(19) United States
(12) Patent Application Publication
(10) Pub. No.: US 2011/0074225 A1
(43) Pub. Date: Mar. 31, 2011

(54) REDUCED POWER CONSUMPTION SENSOR DEVICE AND ILLUMINATION SYSTEM COMPRISING SUCH A SENSOR DEVICE

(75) Inventors: Roger Peter Anna Delnoij, Eindhoven (NL); Willem Franke Pasveer, Eindhoven (NL)

(73) Assignee: KONINKLIJKE PHILIPS ELECTRONICS N.V., EINDHOVEN (NL)

(21) Appl. No.: 12/995,226

(22) PCT Filed: Jun. 4, 2009
(86) PCT No.: PCT/IB2009/052370

§ 371 Date: Nov. 30, 2010

(30) Foreign Application Priority Data
Jun. 11, 2008 (EP) 08157998.9

(51) Int. Cl. H01H 35/00

(52) U.S. Cl. 307/117; 307/116

(57) ABSTRACT

The invention relates to a wireless sensor device configured for sensing motion of an object in an area. The device comprises a motion sensor configured for generating a sensing signal when sensing motion in the area and a signal processor configured for processing the sensing signal. A power supply is provided for providing power to the motion sensor. Furthermore, the wireless sensor device comprises a controller configured for distinguishing, from the sensing signal, large object movements and small object movements of the object in the area. The wireless sensor device is configured to perform one or more power consumption reduction operations upon detection of large object movement. The power consumption reduction operations include temporarily disconnecting the motion sensor from the power supply and decreasing a duty cycle of the signal processor.

### FIELD OF THE INVENTION

The invention relates to the field of wireless sensor devices, to a method of operating such devices and to an illumination system comprising one or more of such wireless sensor device. More specifically, the invention relates to a wireless sensor device comprising a motion sensor, a signal processor and an on-board power supply capable of reducing power consumption.

### BACKGROUND OF THE INVENTION

In recent years, attention has increased for energy saving measures in the field of illumination of areas, such as rooms. As an example, control systems have been developed that activate light sources only when the presence of human beings is detected, using occupancy sensors (e.g. pyroelectric infrared sensors), and to adapt the level of artificial light from the light sources depending on the level of daylight in the area, using light level sensors. Occupancy sensors and light sensors may advantageously be used in combination.

The sensor devices typically need to be installed at particular locations in the area in order to fulfill the sensing function. Installation of such sensor devices is greatly facilitated by providing wireless sensor devices. Such sensor devices are capable of wireless transmission of the sensing data, or derivatives thereof, to the light sources (or a central controller thereof).

For true wireless sensor devices, not only the sensing data should be transmitted wirelessly, but also energizing the sensor devices should not require wire connections. A battery or other energy storage means may be used to accomplish such a wireless sensor device. For such sensor devices, power consumption is critical, o.a. for the lengthening the operating lifetime of the energy storage means.

US 2003/0047671 discloses an object detecting device utilizing a pyroelectric sensor providing a sensing current, a voltage amplifier providing an amplified voltage proportional to the sensing current, and a level monitor providing a detection signal when the amplified voltage exceeds a detection threshold. The device has a standby mode where the voltage amplifier receives a limited source current to provide the voltage of low amplification, and the level monitor provides a wake-up signal when the low amplified voltage exceeds a preliminary threshold lower than the detection threshold. In response to the wake-up signal, the device is switched to an operation mode where the amplifier receives a rated source current to provide a voltage of high amplification for comparison with the detection threshold.

There is a need in the art for a wireless sensor device configured for further reduction of the power consumption.

### SUMMARY OF THE INVENTION

A wireless sensor device configured for sensing motion of an object in an area is proposed. The device comprises a motion sensor configured for generating a sensing signal when sensing motion in the area and a signal processor configured for processing the sensing signal. A power supply is provided for providing power to the motion sensor. Furthermore, the wireless sensor device comprises a controller configured for distinguishing, from the sensing signal, large object movements and small object movements of the object in the area. The controller may possibly use the signal processor for that purpose. The wireless sensor device is configured to perform one or more power consumption reduction operations upon detection of large object movement. The power consumption reduction operations include temporarily disconnecting the motion sensor from the power supply and decreasing a duty cycle of the signal processor.

An illumination system comprising one or more light sources and at least one such wireless sensor device is also proposed.

Furthermore, a method of operating a wireless sensor device configured for sensing motion of an object in an area is proposed. The device comprises a motion sensor configured for generating a sensing signal when sensing motion in the area and a signal processor configured for processing the sensing signal. A power supply is provided for providing power to the motion sensor. Large and small object movements of the object in the area may be distinguished from the sensing signal (or derivatives thereof). One or more power consumption reduction operations can be performed in response to large object movement. The power consumption reduction operations include temporarily disconnecting the motion sensor from the power supply and decreasing a duty cycle of the signal processor.

Large object movement typically involves motion of the complete object (e.g. someone entering a room), while small object movement involves motion of only a part of the object (e.g. someone picking up a telephone).

Power may be interrupted by switching off the power supply or by disconnecting the power supply from the motion sensor or other component.

In the prior art, the amplifier is kept to be less-power consuming in the absence of the wake-up signal, reducing a power requirement. The amplifier, however, only consumes a relatively small amount of power. The invention is based on the insight that the motion sensor (e.g. a pyroelectric infrared motion sensor) and the signal processor are the components mainly responsible for the energy consumption of the wireless sensor device. The defined power consumption reduction operations specifically target these components, thereby prolonging the life time of the power supply.

For some applications, such as lighting applications, a wireless sensor device switches on the light when someone enters a room (i.e. a large object movement). If no further movement is detected, however, the light is not switched off immediately but only after a predetermined period of time to avoid continuous switching between an on-state and an off-state of the light source. Since motion sensing is not required in this period for controlling the light sources, the motion sensor can be switched off temporarily, thereby saving energy.

A lower duty cycle can be used in the processor for processing a signal indicative of large object movement than for processing a small object movement signal. A lower duty cycle generally reflects lower power consumption. The duty cycle of the signal processor may also be adapted in response to large object movement. As an example, if someone has left the room, resulting in large object movement, generally large object movement (viz. someone entering the room again) can be expected before small object movement and, accordingly the duty cycle of the processor can be lowered.

The embodiment of claim 2 provides the advantage of switching on the motion sensor after a predetermined period in order to enable motion detection again. The predetermined period is less than 10 minutes, preferably less than 5 minutes to achieve an optimal balance between energy consumption reduction and sensing functionality of the wireless sensor device.

The embodiments of claims 3 and 4 provide for reduced energy consumption in the period after reconnection of the power supply to the motion sensor.

Generally, the sensing signals of the motion sensor may be amplified before being processed further. This is particularly true for sensing signals resulting from small object movements. The embodiment of claim 6 provides the advantage that the amplifier is powered only after having detected large object movement, thereby saving energy for the wireless sensor device in the period prior to the large object movement.

Pyroelectric infrared (PIR) motion sensors, as defined in claim 7, are suitable for motion detection. Such PIR sensors provide sensing signals indicative of large object movement and small object movements on the basis of temperature differences between the object and the background.

The embodiment of claim 8 is advantageous in that the on-board power supply avoids the need for installing power wires and provides the freedom of installing the wireless sensor device at the desired location.

The embodiment of claim 9 provides the advantage of further prolonging the life time of the power supply by enabling energy harvesting from the ambient light and light emitted from available light sources.

Hereinafter, embodiments of the invention will be described in further detail. It should be appreciated, however, that these embodiments may not be construed as limiting the scope of protection for the present invention.

### BRIEF DESCRIPTION OF THE DRAWINGS

In the drawings:

FIG. 1 is a diagrammatic view of a room comprising a wireless sensor device and an illumination system according to an embodiment of the invention;

FIG. 2 is a schematic illustration of the wireless sensor device of FIG. 1; and

FIGS. 3A-3B provide flow charts of methods of operating the wireless sensor device of FIG. 2.

### DETAILED DESCRIPTION OF THE DRAWINGS

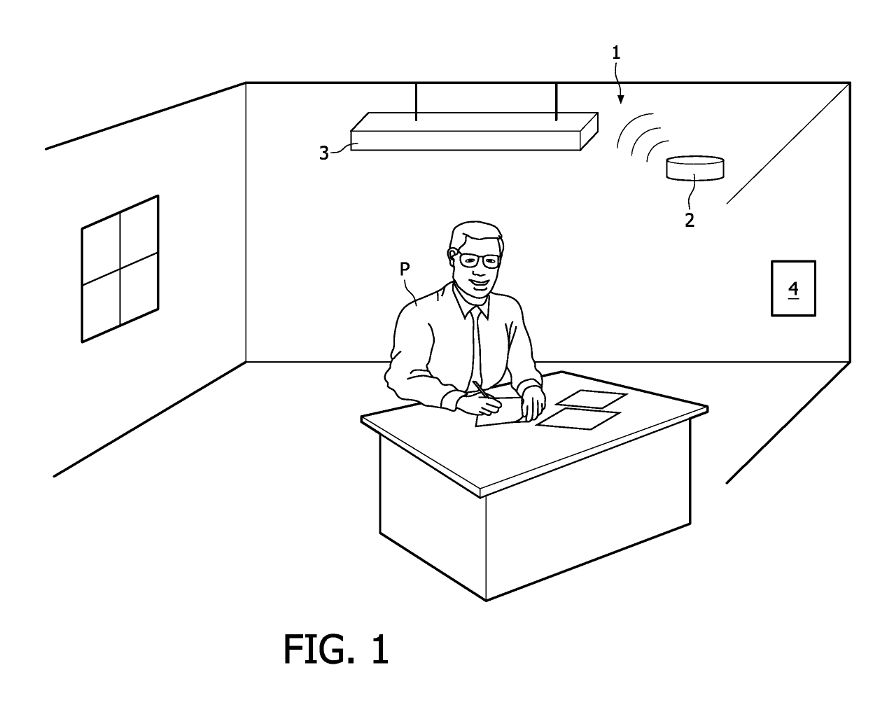

FIG. 1 shows illumination system 1 provided in an area (such as a room) occupied by a person P. The illumination system 1 comprises a wireless sensor device 2 and at least one armature 3 having one or more light sources (not shown). The area may e.g. be an office environment or a domestic environment. Alternatively, a central controller 4 may be present in the room to receive the signals from the wireless sensor device 2 and to provide operation commands for the armature or armatures 3 in the room.

In the present embodiment, the wireless sensor device 2 controls the operation of the armature 3 in response to triggers sensed by the sensing device 2. Such triggers may include the entrance of the person P into a room or a change of the ambient light level in the room. The type of trigger that may be detected depend on the sensors comprised in the wireless sensor device 2. Examples of control of the operation of the armature 3 include switching on/off one or more light sources of the armature, adapting the color and/or brightness of the light emitted by the light sources, redirecting the light of the light sources etc.

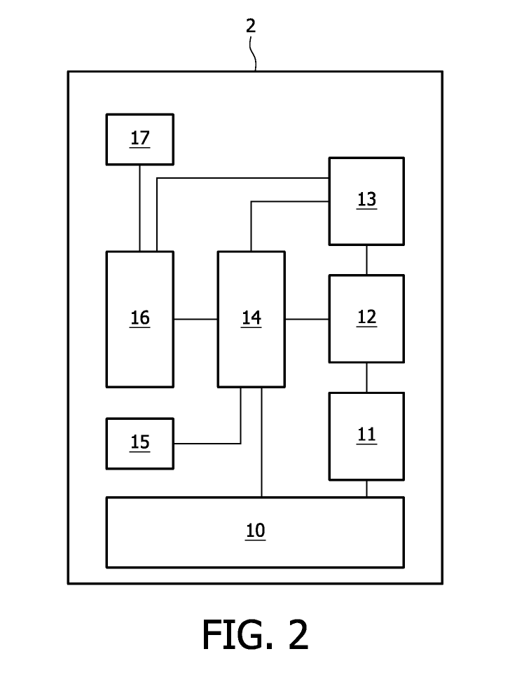

FIG. 2 is a schematic illustration of the wireless sensor device of FIG. 1. The wireless sensor device 2 comprises a motion sensor 10, e.g. a pyro-electric infrared (PIR) sensor. Such a PIR sensor 10 provides sensing signals indicative of large object movement and small object movements on the basis of temperature differences between the object and the background. In the example of FIG. 1, movement of the person P may be detected.

The sensing signals of the PIR sensor 10 are sensing currents. I/V converter 11 converts the signals from the PIR sensor 10 into voltage signals that are subsequently amplified by amplifier 12 to obtain an amplified sensing signal. A signal processor 13 receives the amplified sensing signal for further processing. The signal processor processes the signals with a variable duty cycle, as will be explained below in further detail.

The wireless sensor device has an on-board power supply 14 for providing power to PIR sensor 10, I/V converter 11, amplifier 12 and signal processor 13. The power supply 14 preferably comprises a battery. Energy can be harvested to charge the battery by means of a photo electric module 15, e.g. a solar cell. Photo electric module 15 may also comprise a light sensor used for both sensing and energy harvesting purposes.

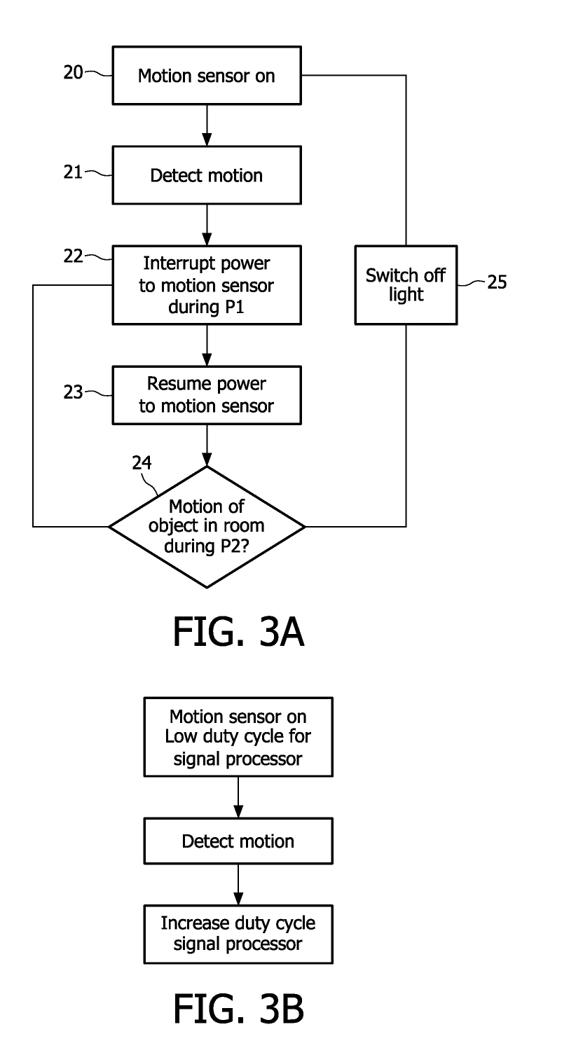

The wireless sensor device 2 contains a controller 16. Controller 16 is configured for controlling the power supply to the PIR sensor 10 and amplifier 12. Moreover, controller 16 may control the duty cycle of signal processor 13. By these means, controller 16 is configured for performing power consumption reduction operations by controlling operation of the PIR sensor 10 and the amplifier 12 and/or the duty cycle of the signal processor 13 as will be explained in further detail with reference to FIGS. 3A and 3B.

Finally, wireless sensor device 2 may comprise a command transmitter 17 configured for transmitting operating commands to the armature 3 of the illumination system 1 (FIG. 1).

In FIG. 3A, a flow chart of performing a power consumption reduction operation is depicted wherein power supply for the PIR sensor is temporarily interrupted by controller 16.

In step 20, PIR sensor 10 is powered by power supply 14. Person P enters a room which is detected by PIR sensor 10 in step 21 as a large movement using signal processor 13. Amplifier 12 may be off and signal processor 13 may be run at a low duty cycle (see FIG. 3B).

In step 22, controller 16 is informed of the large object movement and disconnects the power supply 14 from the PIR sensor 10 for a predetermined period P1. P1 may e.g. be 5 minutes. Of course, during this period P1, the PIR sensor 10 will not be able to detect object movements in the room. However, this is also not necessary since for lighting applications, typically, light remains switched on until some time (e.g. 10-15 minutes) after detecting movement in the room.

After expiry of period P1, controller 16 controls feeding power from power supply 14 to PIR sensor 10 again in step 23. It is noted that PIR sensors generally require considerable time (e.g. 30 seconds-1 minute) before stabilization in order to provide a reliable sensing signal.

After the stabilization time, PIR sensor 10 remains powered during a period P2 to detect object movement in the room (step 24). Amplifier 12 may also be powered and the duty cycle of signal processor 13 may be increased in order to reliably detect small object movements in the room. The latter operation is schematically depicted in the last block of FIG. 3B.

If movement is detected during period P2, controller 16 may again interrupt power feeding from power supply 14 to PIR sensor 10 for a period P1.

If no movement is detected during period P2, controller 16 may operate command transmitter 17 to instruct armature 3 to switch off the light (step 25). Power remains to be supplied from power supply 14 to PIR sensor 10 for detecting object movement.

The duty cycle of the signal processor may be decreased by a variety of triggers, such as the expiry of a time period wherein the PIR sensor 10 did not register object motion in the room.

1. A wireless sensor device (2) configured for sensing motion of an object in an area, the device comprising:
a motion sensor (10) configured for generating a sensing signal when sensing motion in said area;
a signal processor (13) configured for processing said sensing signal;
a power supply (14) arranged for providing power for at least said motion sensor; and
a controller (16) configured for distinguishing, from said sensing signal, large object movements and small object movements of said object in said area and for performing at least one of the following operations upon detection of large object movement:
temporarily interrupting power from said power supply to said motion sensor;
adapting a duty cycle of said signal processor.

2. The wireless sensor device (2) according to claim 1, wherein said controller (16) is configured for interrupting power from said power supply (14) for a predetermined period (P1) and for providing said power from said power supply to said motion sensor (10) after expiry of said period.

3. The wireless sensor device (2) according to claim 2, wherein said wireless device comprises a command transmitter (17) for transmitting commands for a light source (3) and wherein said controller (16) is configured for instructing said command transmitter to transmit a command for switching off said light source after expiry of a second period (P2) subsequent to said predetermined period in the absence of a sensing signal in said second period.

4. The wireless sensor device (2) according to claim 2, wherein said controller (16) is further configured for interrupting power from said power supply (14) to said motion sensor (10) after expiry of a second period subsequent to said predetermined period in response to a sensing signal in said second period.

5. The wireless sensor device (2) according to claim 1, wherein said controller (16) is further configured for increasing said duty cycle of said signal processor (13) in response to a sensing signal indicating large object movement.

6. The wireless sensor device (2) according to claim 1, wherein said device further comprises an amplifier (12) arranged for receiving said sensing signal from said motion sensor (10) to obtain an amplified sensing signal and wherein said controller (16) is further configured for providing power from said power supply (14) to said amplifier upon detection of large object movement.

7. The wireless sensor device (2) according to claim 1, wherein said motion sensor is a pyro-electric infrared motion sensor (10).

8. The wireless sensor device according to claim 1, wherein said power supply is a battery (14).

9. The wireless sensor device according to claim 1, further comprises a photo electric module (15) for providing energy to said power supply.

10. An illumination system (1) comprising one or more light sources and at least one wireless sensor device (2) according to claim 1.

11. A method of operating a wireless sensor device (2) configured for sensing motion of an object in an area using:
a motion sensor (10) configured for generating a sensing signal when sensing motion in said area;
a signal processor (13) configured for processing said sensing signal;
a power supply (14) arranged for providing power for at least said motion sensor; the method comprising the steps of:
distinguishing, on the basis of said sensing signal, large object movement and small object movements of said object in said area;
interrupting power from said power supply to said motion sensor in response to a sensing signal indicating large object movement and/or
decreasing a duty cycle of said signal processor in response to a sensing signal indicating large object movement.

12. The method of operating a wireless sensor device (2) configured for sensing motion of an object in an area using:
a motion sensor (10) configured for generating a sensing signal when sensing motion in said area;
a signal processor (13) configured for processing said sensing signal;
a power supply (14) arranged for providing power for at least said motion sensor; the method comprising the steps of:
distinguishing, on the basis of said sensing signal, large object movement and small object movements of said object in said area;
interrupting power from said power supply to said motion sensor in response to a sensing signal indicating large object movement and/or
decreasing a duty cycle of said signal processor in response to a sensing signal indicating large object movement, further comprising the steps of the controller of claim 2.
